(19) United States
(12) Patent Application Publication
(10) Pub. No.: US 2014/0089857 A1
(43) Pub. Date: Mar. 27, 2014

(54) METHOD AND APPARATUS FOR ENTERING A CLIENT FUNCTION MODULE

(71) Applicant: Tencent Technology (Shenzhen) Company Limited, Shenzhen (CN)

(72) Inventors: Qing WANG, Shenzhen (CN); Haoran GUO, Shenzhen (CN); Yixia YUAN, Shenzhen (CN); Xunchang ZHAN, Shenzhen (CN); Chunyou LIN, Shenzhen (CN); Pengtao LI, Shenzhen (CN); Jiashun SONG, Shenzhen (CN)

(73) Assignee: Tencent Technology (Shenzhen) Company Limited, Shenzhen (CN)

(21) Appl. No.: 14/095,923

(22) Filed: Dec. 3, 2013

Related U.S. Application Data
(63) Continuation of application No. PCT/CN2013/080714, filed on Aug. 2, 2013.

(30) Foreign Application Priority Data
Aug. 6, 2012 (CN) 201210284324.3

(51) Int. Cl. G06F 3/0481; G06F 3/0484

(52) U.S. Cl. CPC G06F 3/04817; G06F 3/04842
USPC 715/835

(57) ABSTRACT

The present invention discloses a method and an apparatus for entering a client function module directly. The method includes: intercepting an event generated by a function module included in a client, and obtaining an icon corresponding to the function module according to the event and displaying the icon; receiving a click event submitted by a user through the displayed icon, and obtaining a function identifier of the function module corresponding to the displayed icon; and entering the corresponding function module according to the function identifier without going through the main user interface of the application providing the function module.

### RELATED APPLICATIONS

This application is a continuation application of PCT Patent Application No. PCT/CN2013/080714, entitled “METHOD AND APPARATUS FOR ENTERING A CLIENT FUNCTION MODULE” filed on Aug. 2, 2013, which claims priority to Chinese Patent Application No. 201210284324.3, entitled “METHOD AND APPARATUS FOR ENTERING A CLIENT FUNCTION MODULE,” filed on Aug. 6, 2012, both of which are incorporated by reference in their entirety.

### TECHNICAL FIELD

The disclosed implementations relate generally to the field of computers, and in particular, to a method and an apparatus for entering a client function module.

### BACKGROUND

With the popularity of smart phones, various kinds of mobile phone application software emerge in an endless stream. For example, mobile phone system maintenance software is a common kind of mobile phone application software. The mobile phone system maintenance software includes multiple function modules, and each function module provides a respective function.

For example, the mobile phone system maintenance software includes a private information module. When a mobile phone receives private information, the private information module generates a private event, and stores the private information in a private mail box; and a user may start the mobile phone system maintenance software manually from an application list of the mobile phone (e.g., from application icons shown on the home screen of the mobile phone) and enter the private information module to view the private information (e.g., private messages). For another example, the mobile phone system maintenance software includes an information intercepting module. When a mobile phone receives malicious information (e.g., SPAM emails, or Phishing emails), the information intercepting module generates an interception event to intercept the malicious information and store the malicious information in a malicious information mail box; and a user may start the mobile phone system maintenance software manually from an application list of the mobile phone and enter the information intercepting module to view the intercepted malicious information.

In the process of implementing the present invention, the inventor finds that the prior art at least has the following problems:

A user needs to find the mobile phone system maintenance software in an application list of the mobile phone and start the mobile phone system maintenance software manually, and then enter a corresponding function module to view private information or intercepted malicious information. The process of the operation of the user is long, and inconvenient.

### SUMMARY

In order to improve the convenience of an operation, the present invention provides a method and an apparatus for entering a client function module. The technical solution is as follows:

A method for entering a client function module (e.g., providing direct access to a sub-function of an application installed on a mobile device) includes: intercepting an event generated by a function module included in a client (e.g., a functional module of an application installed on the mobile device), and obtaining and displaying an icon corresponding to the function module according to the event; receiving a click event submitted by a user through the icon, and obtaining a function identifier of the function module corresponding to the icon; and entering the corresponding function module (e.g., providing direct access to the corresponding function module) according to the function identifier, without first invoking a main user interface of the application.

An apparatus for entering a client function module includes: a first obtaining module, configured to intercept an event generated by a function module included in a client, and obtain and display an icon corresponding to the function module according to the event; a second obtaining module, configured to receive a click event submitted by a user through the icon, and obtain a function identifier of the function module corresponding to the icon; and an entering module, configured to enter the corresponding function module according to the function identifier.

In the embodiments of the present invention, an event generated by a function module included in a client is intercepted, an icon corresponding to the function module is obtained according to the event and the icon is displayed, a click event submitted by a user through the icon is received, a function identifier of the function module corresponding to the icon is obtained, and the corresponding function module is entered according to the obtained function identifier. In this way, when a certain function module of the client generates an event, the user may be informed through the icon corresponding to the function module, and the user may directly enter the corresponding function module through the icon, which improves the convenience of the operation.

### BRIEF DESCRIPTION OF DRAWINGS

The aforementioned implementation of the invention as well as additional implementations will be more clearly understood as a result of the following detailed description of the various aspects of the invention when taken in conjunction with the drawings. Like reference numerals refer to corresponding parts throughout the several views of the drawings.

FIG. 1 is a flowchart of a method for entering a client function module according to Embodiment 1 of the present invention;

FIG. 2 is a flowchart of a method for entering a client function module according to Embodiment 2 of the present invention; and

FIG. 3 is a schematic structural diagram of an apparatus for entering a client function module according to Embodiment 3 of the present invention.

FIGS. 4A-4O are exemplary user interface for entering a client function module in accordance with some embodiments.

FIG. 5 is a schematic block diagram of a system for entering a client function module in accordance with some embodiments.

### DETAILED DESCRIPTION

To make the technical solutions and advantages of the present invention clearer, embodiments of the present invention are further described in detail in the following with reference to the accompanying drawings.

Embodiment 1

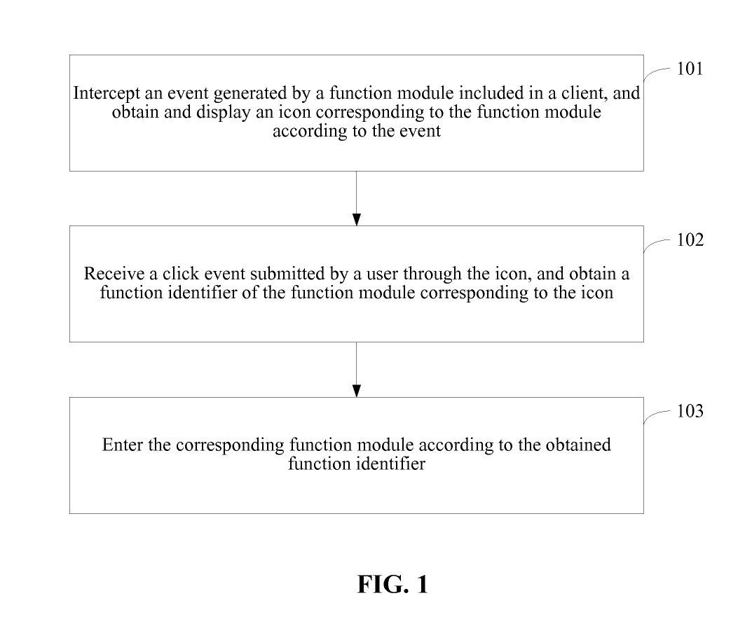

As shown in FIG. 1, an embodiment of the present invention provides a method for entering a client function module, which includes:

Step 101: Intercept an event generated by a function module included in a client, and obtain and display an icon corresponding to the function module according to the event.

Step 102: Receive a click event submitted by a user through the icon, and obtain a function identifier of the function module corresponding to the icon.

Step 103: According to the obtained function identifier, enter the corresponding function module.

In the embodiment of the present invention, an event (e.g., a notification event of newly received private message, a notification event newly intercepted malicious information, or a reminder to run a performance test) generated by a function module (e.g., a private email module, a malicious information module, a performance test module) included in a client (e.g. a mobile phone, a PDA, a smartphone, etc.) is intercepted, an icon corresponding to the function module is obtained according to the event and the icon is displayed (e.g., on a home screen of the client, or a lock screen of the client), a click event (e.g., a touch input received on a touch-sensitive display of the client) submitted by a user through the icon is received, a function identifier of the function module corresponding to the icon is obtained, and the corresponding function module is entered according to the obtained function identifier. For example, in response to the click event, the home screen displaying the icon is replaced with an interface of the function module, such as a list of private mail messages shown in a private mail box interface, a list of malicious messages and SMSs shown in a malicious information mail box interface, or a list of performance tests shown in a performance test interface. In this way, when a certain function module of the client generates an event, a user may be informed through the icon corresponding to the function module, and the user may directly enter the corresponding function module through the icon, which improves the convenience of the operation.

Embodiment 2

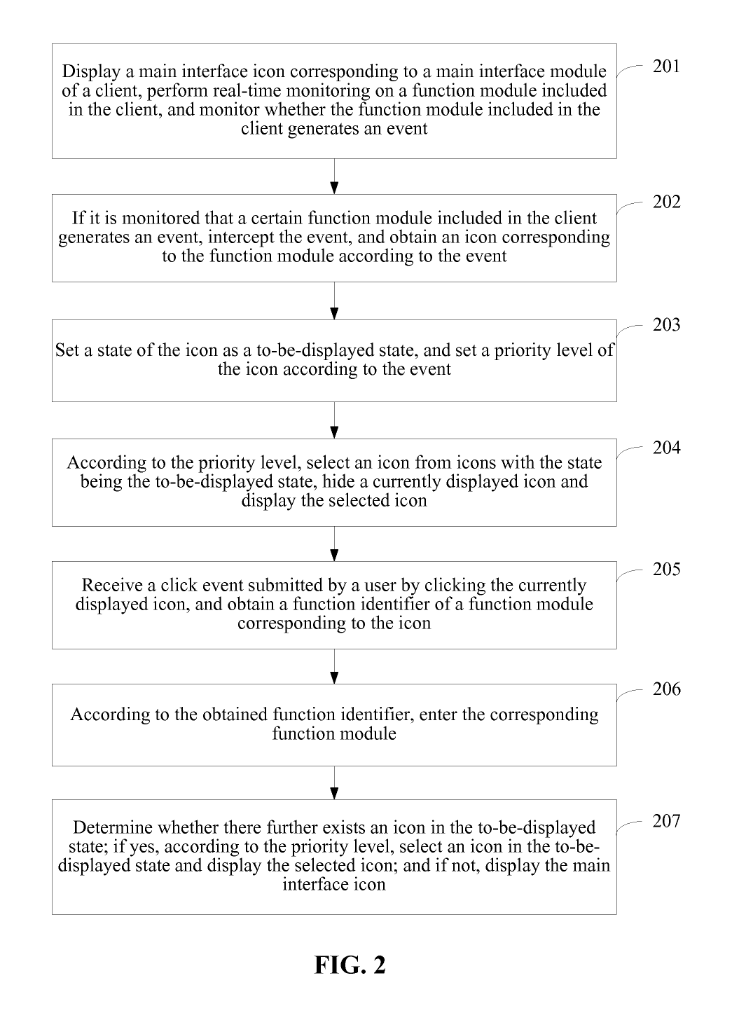

As shown in FIG. 2, an embodiment of the present invention provides a method for entering a client function module, which includes:

Step 201: Display a main interface icon corresponding to a main interface module (e.g., a manager application that provides multiple functions using multiple function modules of one or more applications) of a client, perform real-time monitoring on a function module included in the client, and monitor whether the function module included in the client generates an event.

The client provides a monitoring progress residing in the background, and performs real-time monitoring on each function module included in the client (e.g., each function module managed by the manager application program) through the monitoring process.

The client includes multiple function modules, the main interface module is one of the function modules included in the client, each function module included in the client corresponds to an icon, and an icon corresponding to the main interface module is the main interface icon.

For example, in this embodiment, the client being system maintenance software (e.g., a manager application) is taken as an example for illustration, but this is not intended to limit the protection scope of the present invention. The client includes multiple function modules, which separately are: a private information module, an information intercepting module, a client-side performance test module and a main interface module. The private information module corresponds to a private information interface and a private mail box, where the private mail box is used to store private information (e.g., private emails, SMSs, chat messages, etc.) received by the private information module. The information intercepting module corresponds to an information intercepting interface and a malicious information mail box, where the malicious information mail box is used to store malicious information (e.g., SPAM emails, text messages, voice mail messages, Phishing emails, viruses, Trojan programs, etc.) intercepted by the information intercepting module. The client-side performance test module corresponds to a client performance test interface and a key item list, where the key item list is used to store the names of key items included in the client, and the key item is a key indicator of parameters affecting the operation and/or performance of the client. The main interface module corresponds to a main interface of the client and a function list, where the function list is used to store the names of the function modules included in the client or the names of the functions managed by the main interface module.

If the function module included in the client generates an event, the event generated by the function module may be intercepted according to the following steps, which include:

Step 202: If it is monitored that a certain function module included in the client generates an event, intercept the event, and obtain an icon corresponding to the function module according to the event.

Specifically, if it is monitored that a certain function module included in the client generates an event, the event generated by the function module is intercepted, an icon corresponding to the event is obtained from stored correspondence between events and icons, and the obtained icon is determined to be the icon corresponding to the function module.

Step 203: Set a state of the icon as a to-be-displayed state, and set a priority level of the icon according to the event.

Specifically, a state of the icon is set as a to-be-displayed state, according to the event, a priority level corresponding to the event is obtained from correspondence between events and priority levels, and the priority level of the icon is set as a priority level corresponding to the event.

Each function module included in the client corresponds to a priority level, and the event and priority level corresponding to each function module are stored in advance in the correspondence between events and priority levels.

For example, when the client receives one piece of information, the information includes an identifier of a sender, and the private information module included in the client may detect whether the information is private information according to a stored private contact list, where the private contact list includes an identifier of a private contact. If the information is private information, the private information module generates a private event and stores the private information in the private mail box.

If it is detected that the information is non-private information, the information intercepting module included in the client detects whether the information is malicious information according to a stored blacklist. If the information is malicious information, the information intercepting module generates an interception event, and stores the malicious information in a malicious information mail box.

The client-side performance test module included in the client records time for when performance testing is last performed in the client, if a time difference between the current time and the time for the last performance testing exceeds a preset time, the client-side performance test module included in the client generates a performance test event.

In this embodiment, the correspondence between events and icons shown in Table 1 is stored in advance.

TABLE 1

| Event | Icon |
|---|---|
| Private event | Private icon |
| Interception event | Interception icon |
| Performance Test | Performance Test |
| event | icon |
| . . . | . . . |

In this embodiment, a priority level corresponding to the private information module included in the client is 3, a priority level corresponding to the information intercepting module is 2 and a priority level corresponding to the client-side performance test module is 1; a private event corresponding to the private information module and the priority level 3, an interception event corresponding to the information intercepting module and the priority level 2, and a test event corresponding to the client-side performance test module and the priority level 1 are stored in advance in the correspondence between events and priority levels shown in Table 2.

TABLE 2

| Event | Priority level |
|---|---|
| Private event | 3 |
| Interception event | 2 |
| Performance Test | 1 |
| event | |
| . . . | . . . |

If it is monitored that the private information module included in the client generates a private event, the private event generated by the private information module is intercepted, a private icon corresponding to the private event is obtained from the correspondence between events and icons shown in Table 1, a state of the private icon is set as a to-be-displayed state, according to private event a priority level 3 is obtained from the correspondence between events and priority levels shown in Table 2, and a priority level of the private icon is set as 3.

If it is monitored that the information intercepting module include by the client generates an interception event, the interception event generated by the information intercepting module is intercepted, an interception icon corresponding to the interception event is obtained from the correspondence between events and icons shown in Table 1, a state of the interception icon is set as a to-be-displayed state, according to the interception event the priority level 2 is obtained from the correspondence between events and priority levels shown in Table 2, and a priority level of the interception icon is set as 2.

If it is monitored that the client-side performance test module included in the client generates a performance test event, the performance test event generated by the client-side performance test module is intercepted, a performance test icon corresponding to the performance test event is obtained from the correspondence between events and icons shown in Table 1, a state of the test icon is set as a to-be-displayed state, according to test event a priority level 1 is obtained from the correspondence between events and priority levels shown in Table 2, and a priority level of the test icon is set as 1.

Step 204: According to the priority level, select an icon from icons with the state being a to-be-displayed state, hide a currently displayed icon and display the selected icon.

Specifically, an icon with the greatest priority level is selected from the icons with the state being a to-be-displayed state, a currently displayed icon is hidden, and the selected icon is displayed.

Furthermore, after a selected icon is displayed, the state of the selected icon is set to be a displayed state.

For example, assuming that the icons with the current state being the to-be-displayed state include a private icon, an interception icon and a performance test icon, the private icon with the greatest priority level is selected, the currently displayed main interface icon is hidden, the selected private icon is displayed, and the state of the private icon is set to be a displayed state.

After the icon is displayed, a user may submit a click event by clicking the icon, and perform the following steps, which separately are:

Step 205: Receive a click event submitted by the user by clicking the currently displayed icon, and obtain a function identifier of a function module corresponding to the icon.

Specifically, a click event submitted by the user by clicking an icon is received, and according to the icon, the function identifier of the corresponding function module is obtained from stored correspondence between icons and function identifiers, where the function identifier is used to identify the function module included in the client.

Furthermore, after the user clicks the currently displayed icon, the currently displayed icon may be hidden.

The icon and the function identifier corresponding to each function module included in the client are stored in advance in the correspondence between icons and function identifiers. For example, a private icon and a function identifier ID1 corresponding to the private information module included in the client, an interception icon and a function identifier ID2 corresponding to the information intercepting module, a performance test icon and a function identifier ID3 corresponding to the client-side performance test module, and a main interface icon and a function identifier ID4 corresponding to the main interface module are stored in advance in the correspondence between icons and function identifiers shown in Table 3.

TABLE 3

| Icon | Function identifier |
|---|---|
| Private icon | ID1 |
| Interception icon | ID2 |
| Test icon | ID3 |
| Main interface icon | ID4 |
| . . . | . . . |

If a user submits a click event by clicking a displayed private icon, the click event submitted by the user is received, and according to the private icon, the function identifier ID1 of the corresponding private information module is obtained from the stored correspondence between icons and function identifiers shown in Table 3, and the displayed private icon is hidden.

Step 206: According to the obtained function identifier, enter the corresponding function module.

Specifically, according to the obtained function identifier, a function module corresponding to client software is determined, a function interface corresponding to the function module is opened and to-be-displayed content of the function module is displayed in the function interface, without first displaying the main interface or home interface of the application that provides the function module.

For example, it is determined according to the function identifier ID1 that the corresponding function module is a private information module, the opened function interface corresponding to the private information module is a private information interface, the to-be-displayed content obtained from a private mail box corresponding to the private information module is private information, and the obtained private information is displayed in the private information interface, without first displaying the main interface or home interface of the mail application or the manager application that provides the private information module.

Step 207: Determine whether there further exists an icon with the state being the to-be-displayed state, if yes, according to the priority level, select an icon in the to-be-displayed state and display the selected icon; and if not, display the main interface icon.

For example, it is determined that there further exist an interception icon and a test icon in the to-be-displayed state, according to the priority level the interception icon is selected, the selected interception icon is displayed; when a click event submitted by a user through the interception icon is received, according to the interception icon the function identifier ID2 of the corresponding information intercepting module is obtained from the correspondence between icons and function identifiers shown in Table 3, the displayed interception icon is hidden, according to the function identifier ID2 the corresponding function module is determined to be the information intercepting module, an information intercepting interface corresponding to the information intercepting module is opened, to-be-displayed content obtained from the malicious information mail box corresponding to the information intercepting module is malicious information, and the obtained malicious information is displayed in the information intercepting interface, without first displaying the main interface or home interface of the virus scan application, SPAM filter application, mail application, text messaging application, or the manager application that provides the private information module.

It is determine that there further exists a test icon in the to-be-displayed state, according to the priority level the test icon is selected, the selected test icon is displayed; when a click event submitted by the user through the test icon is received, according to the test icon the function identifier ID3 of the corresponding client-side performance test module is obtained from the correspondence between icons and function identifiers shown in Table 3, the displayed test icon is hidden, according to the function identifier ID3 the corresponding function module is determined to be the client-side performance test module, the client test interface corresponding to the client-side performance test module is opened, the to-be-displayed content obtained from the key item list corresponding to the client-side performance test module is the names of key items, and the obtained names of the key items are displayed in the client test interface, without first displaying the main interface or home interface of the performance management application or the manager application that provides the private information module.

If it is determined that there does not exist an icon in the to-be-displayed state, the main interface icon is displayed; when a click event submitted by the user through the main interface icon is received, according to the main interface icon the function identifier ID4 of a corresponding main interface module is obtained from the correspondence between icons and function identifiers shown in Table 3, according to the function identifier ID4 the corresponding main interface module is determined, a main interface corresponding to the main interface module is opened, the to-be-displayed content obtained from a function list corresponding to the main interface module include the names of the function modules included in the client, and the obtained names of the function module are displayed in the main interface.

In the embodiment of the present invention, an event generated by a function module included in a client is intercepted, an icon corresponding to the function module is obtained according to the event and the icon is displayed, a click event submitted by a user through the displayed icon is received, a function identifier of the function module corresponding to the displayed icon is obtained, and the corresponding function module is entered according to the obtained function identifier. In this way, when a certain function module of the client generates an event, the user may be informed through the icon corresponding to the function module, and the user may directly enter the corresponding function module through the icon, which improves the convenience of the operation.

Embodiment 3

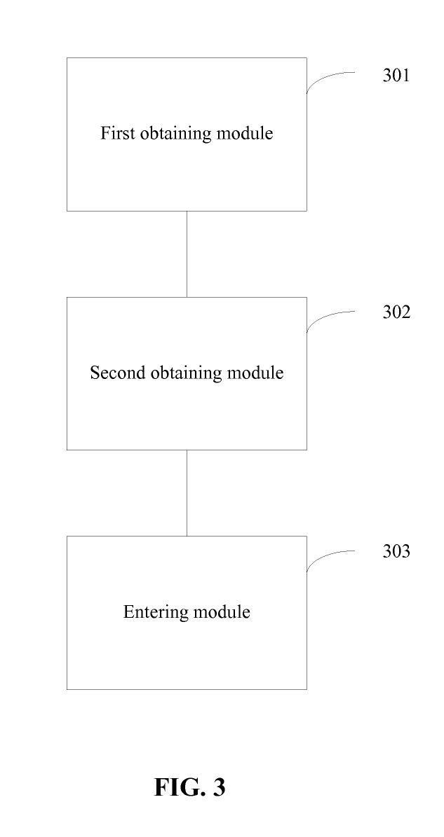

As shown in FIG. 3, an embodiment of the present invention provides an apparatus for entering a client function module, which includes: a first obtaining module 301, configured to intercept an event generated by a function module included in a client, and obtain and display an icon corresponding to the function module according to the event; a second obtaining module 302, configured to receive a click event submitted by a user through the icon, and obtain a function identifier of the function module corresponding to the icon; and an entering module 303, configured to enter the corresponding function module according to the obtained function identifier.

The first obtaining module 301 includes: an intercepting unit, configured to intercept the event generated by the function module included in the client; a first obtaining unit, configured to obtain, according to the event, the icon of the function module corresponding to the event from stored correspondence between events and icons; a setting unit, configured to set a state of the icon as a to-be-displayed state and set a priority level of the icon according to the event; and a displaying unit, configured to select an icon in the to-be-displayed state according to the priority level, and display the selected icon.

The setting unit includes: a first setting subunit, configured to set the state of the icon as the to-be-displayed state; an obtaining subunit, configured to obtain, according to the event, a corresponding priority level from stored correspondence between events and priority levels; and a second setting subunit, configured to set the priority level of the icon as the obtained priority level.

The second obtaining module 302 includes: a receiving unit, configured to receive a click event submitted by a user through the displayed icon; and a second obtaining unit, configured to obtain the function identifier of the function module corresponding to the icon from stored correspondence between icons and function identifiers.

The entering module 303 includes: an opening unit, configured to determine the corresponding function module according to the obtained function identifier and open a function interface of the function module; and a displaying unit, configured to obtain to-be-displayed content corresponding to the function module, and display the obtained to-be-displayed content in the function interface.

Furthermore, the apparatus further includes: a monitoring module, configured to perform real-time monitoring on each function module included in the client, and to monitor whether any function module included in the client generates an event.

In the embodiment of the present invention, an event generated by a function module included in a client is intercepted, an icon corresponding to the function module is obtained according to the event and the icon is displayed, a click event submitted by a user through the displayed icon is received, a function identifier of the function module corresponding to the displayed icon is obtained, and the corresponding function module is entered according to the obtained function identifier. In this way, when a certain function module of the client generates an event, the user may be informed through the icon corresponding to the function module, and the user may directly enter the corresponding function module through the icon, which improves the convenience of the operation.

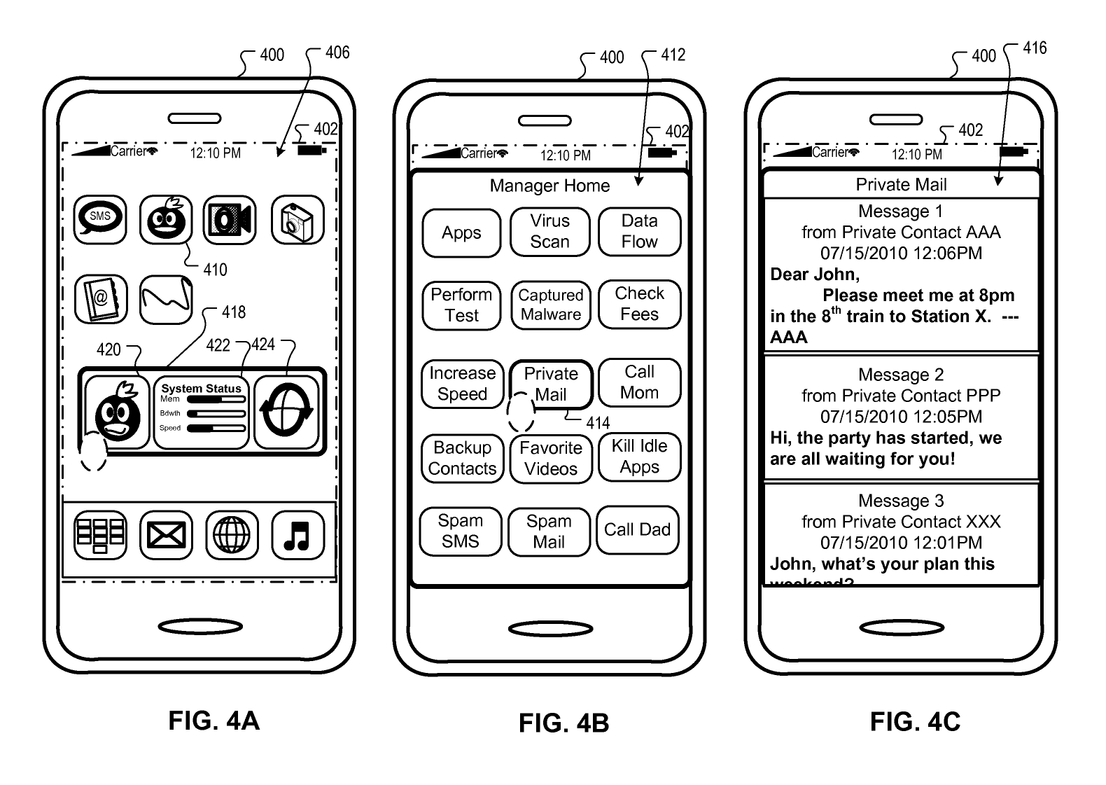

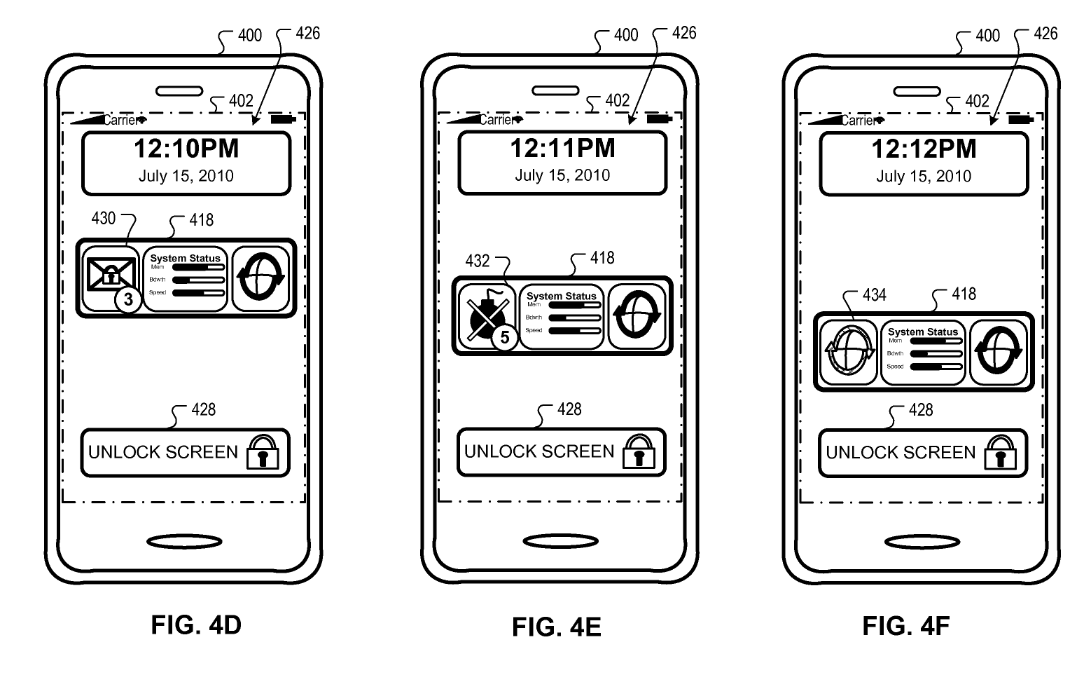

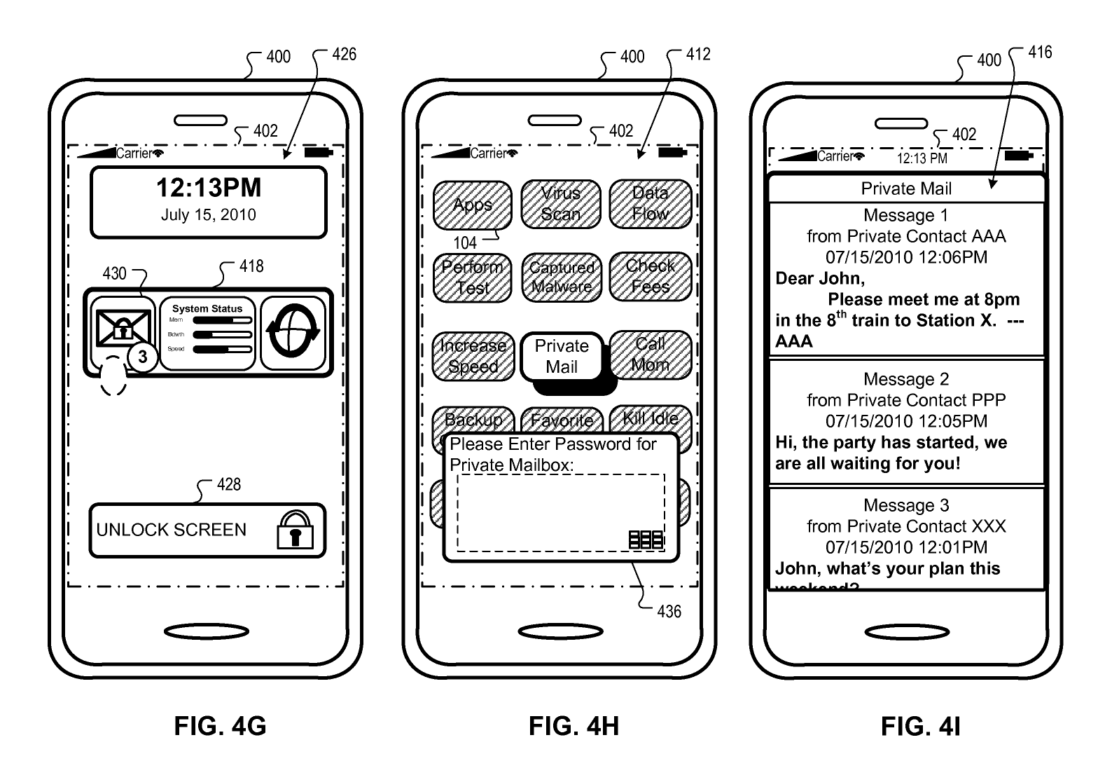

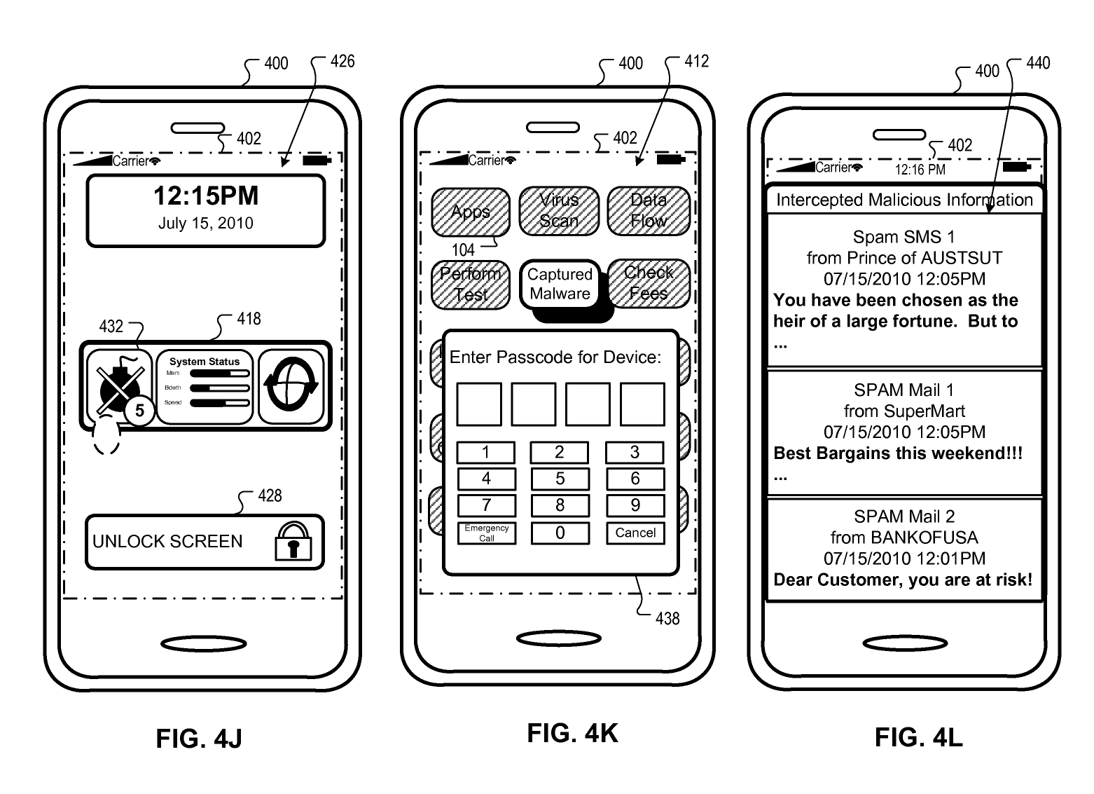

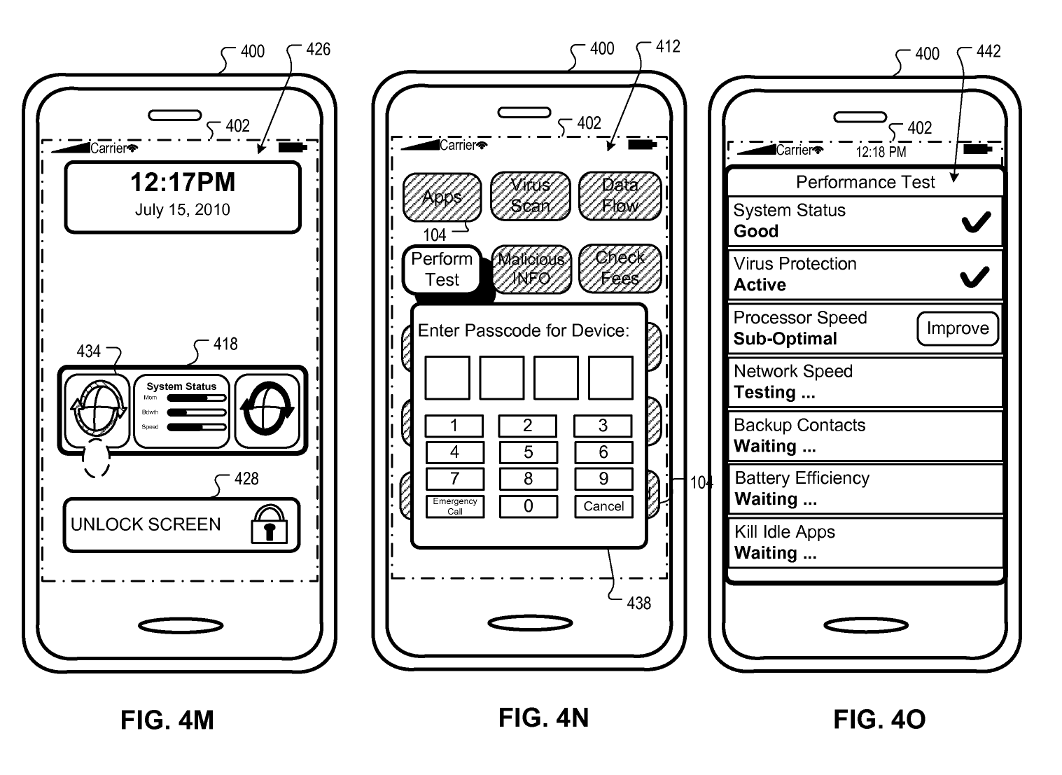

FIGS. 4A-4O illustrate exemplary user interfaces for providing direct access to particular function modules based on event monitoring. FIGS. 4A-4O are provide to illustrate the exemplary methods, processes, and apparatus described above.

FIGS. 4A-4C illustrate exemplary user interfaces of a main interface program (e.g., a manager program), and how a user can access a main interface (e.g., a home interface) of the main interface program (e.g. the manager program), and then access a particular function module (e.g., the private information module) provided or managed by the main interface module (e.g., the manager program).

As shown in FIG. 4A, a mobile device 400 (e.g., a smart phone) has a touch-sensitive display 402. On the touch-sensitive display 402, the mobile device 400 presents a main device interface 406 (e.g., a home screen). The main device interface 406 acts as a “desktop” and presents a plurality of application icons for application programs, such as a icon for an instant message application, an icon for a manager application, an icon for a video camera application, an icon for a photos application, an icon for a contact book application, an icon for a stock quotes program, etc. In some embodiments, the device also presents a special container that holds icons for applications that are most frequently accessed by the user, such as a telephone application, an email application, a web browser application, and a media player application. During normal operation, the user can select a respective icon (e.g., by providing a touch input on the icon) for an application, and invoke the application. Normally, once an application is selected from the home screen of the device, the device executes the application and displays the main interface of the application on the display 402. In some embodiments, the device remembers the state of the application when the application was last used, and displays the user interface corresponding to the last state of the application on the display 402. Since a mobile device has a limited screen space, normally, the display 402 presents the user interface of one application or function module at a time, even if there may be more than one user applications running or suspended in the background.

In some embodiments, a manager program is provided on the device 400, as represented by the icon 410 shown on the home screen 406. The manager program optionally manages the multiple function modules, each providing a different function to the user, and having a respective user interface for interacting with the user. In some embodiments, the manager program has its own function modules, and sometimes, the manager program serves as a portal and provides access to the function modules of other applications executing on the device. Typically, the user can invoke the manager program by selecting the icon 410. In response to the selection of the icon 410, the main interface 412 is replaced by the main interface 416 of the manager program on the display 402. In some embodiments, the main interface 416 of the manager program includes a plurality of icons each representing a respective function module, such as a function module for adding and deleting applications or modules from the manager program, a virus scan module, a network data flow management module, a performance testing module, a module for intercepting malicious information, a module for checking and managing the various fees (e.g., fees for calls, text messages, internet surfing, and various subscription services, etc.) incurred by the user for using the device 400, a module for improving the speed of the device, a module for presenting private messages, a module for making a call to mom, a module for backing up contacts, a module for displaying a list of the user's favorite videos, a module for terminating all idle apps in the background, a module for managing spam text messages, a module for managing spam mail messages, a module for making a call to dad, etc. In some embodiments, the manager application manages sub-functional modules of other applications. For example, a mail application installed on the device may provide an inbox module, a composer module, a private mail box module, etc., where each module has its own interface, and can be accessed from the main interface of the mail application through interaction with various user interface elements presented on the main interface of the mail application. For another example, the call application installed on the device may provide a call interface in which a user can select mom's phone number, and make a call to mom. For another example, the text message application and the mail application may each provide a malicious information filter module, that identifies malicious text messages and mail messages respectively, and store them in respective malicious information folders for user review. In some embodiments, the manager program provides individual function modules that provide direct access to these sub-functions of other applications installed on the device, when the user selects the corresponding icon 410 corresponding to the function modules of these sub-functions on the main interface 412 of the manager program. In some embodiments, the manager program implements its own modules that provide different functions to the user. In some embodiments, the manager program provides its own modules that combine the similar sub-functions of multiple applications. For example, the malicious information interception module provided by the manager application can combine and utilize the functions of the spam filter module of the text message application and the spam filter module of the mail application. For another example, in some embodiments, the performance testing module of the manager program includes various tests that utilize sub-functions of other performance enhancement programs, and various tests implemented by the manager program itself. In various embodiments, the main interface 412 also includes other user interface elements for other navigating the different interfaces within the manager program.

Normally, when the user selects an icon (e.g., the icon 414 for the private information module) from the main interface of the manager program, the device displays the respective interface of the private information module on the display 402. Even though the private information module may be provided by another application, such as a mail application, the main interface of the mail application is not displayed before the user can access the respective interface of the private mail module. As shown in FIG. 4C, the user interface 416 of the private mail module is displayed on the display 402 in response to the user's selection of the icon. In some embodiments, the device (e.g., the manager program) determines whether the private information module requires a different password as the main device, and if so, the device (or the manager program) presents an authentication interface of the private information module first on the display 402. Once the user passes the authentication of the private information module, the user interface 416 can be presented on the display 402.

Other than the normal invocation of the individual function module of the manager application, as described above, in some embodiments, the manager application can provide an additional way of accessing the main interface of the manager application, and one or more function modules provided by the manager application. As shown in FIG. 4A, a floating window 418 is displayed over the main interface (e.g., the home screen) of the device. In some embodiments, the floating window 418 may be a pop-up window that is only displayed when particular predetermined criteria are triggered. In some embodiments, the floating window 418 is a banner that is constantly displayed over the home screen of the device, and can be pushed around the home screen by the user's touch input if the floating window visually obscures one or more icons that the user wishes to see in the home screen.

In some embodiments, as shown in FIG. 4A, the floating window 418 includes an icon 420 for accessing the main interface 412 of the manager program. In other words, the user may cause the main interface 418 of the manager program to be displayed on the display 402 by selecting either the icon 410 or the icon 420. In some embodiments, the floating window 418 is optionally displayed over a lock screen of the device, and if the user selects the icon 420, the device presents the authentication interface of the device first. When the user passes the authentication of the device, the device displays the main interface 412 of the manager application directly, without first displaying the home screen of the device.

In some embodiments, the floating window 418 optionally displays one or more other user interface elements, such as a system status indicator 422 that displays in real-time one or more parameters (e.g., speed, memory usage, number of background applications, battery level, network bandwidth, device health, etc.) for measuring the system's current performance or status. In some embodiments, the floating window 418 further displays an icon 424 for invoking an optimization function of the manager program. For example, by selecting the icon 424 the user can start an optimization process that performs one or more predetermined optimization procedures, such as memory cleaning, killing background applications, releasing resources, restarting network connection, battery optimization, etc. In some embodiments, the user can select the icon 424 to perform the optimization process without leaving the home screen or the lock screen in which the floating window 418 is currently displayed.

In some embodiments, as described above, the icon 420 for invoking the main interface of the manager program is displayed when the device has not intercepted any events that are generated by other function modules of the manager program. In other words, when there are no events indicating that the user may wish to access a particular function module of the manager program, the device displays the icon 420 of the manager program in the floating window 418, and the user can access the main interface of the manager program by selecting the icon 420. As shown in FIGS. 4A-4C, when the user selects the icon 420 displayed in the floating window 418 as shown in FIG. 4A, the main interface 412 of the manager program is displayed as shown in FIG. 4B; and when the user selects a particular function module (e.g., the icon 414 of the private information module) in the main interface of the manager program, the respective interface 416 of the private information module is displayed. The respective interface 416 of the private information module displays a list of private messages (e.g., private e-mail messages, and/or private text messages, and/or private voice mail messages, and/or private social-media messages, etc.) that are currently available on the device.

FIGS. 4D-4F illustrate exemplary icons that can be displayed in the floating window in response detection of events generated by various function modules managed or provided by the manager application. In FIGS. 4D-4F, the floating window 418 is displayed over a lock screen of the device. For example, after the device has been idle for a sufficient amount of time, the home screen of the device 400 is optionally replaced by a lock screen 426, and the floating window 418 originally displayed over the home screen can now be displayed over the lock screen 426 of the device. When the device is in the locked state, the user cannot access the home screen without first passing the authentication interface of the lock screen 426. In some embodiments, the lock screen 426 includes a user interface element 428 for invoking the authentication interface of the device. The user can enter the password for the device in the authentication interface of the device.

As shown in FIG. 4D, when the device or the manager program monitors the function modules that it manages in the background, and determines whether any events have been generated by any of the function modules. For example, if a private mail message has been received by the private information module, a private event is generated by the private information module. According to the processes described above, an icon 430 for the private information module is identified by the manager program. The state of the icon 430 is changed to a to-be-displayed state, and the icon 430 is displayed in the floating window 418. In some embodiments, since the screen space is limited, the icon 430 replaces the icon 420 in the floating window 418. In some embodiments, the icon 430 includes a badge indicating the number of private messages that have been received. In some embodiments, the badge is continuous updated if the user does not select the icon 430 for an extended period of time, and more private messages are obtained during that extended period of time.

FIG. 4E shows that, when malicious information has been detected or intercepted by the malicious information interception module, an interception event is generated by the malicious information interception module. According to the processes described above, an icon 432 for the interception module is identified by the manager program. The state of the icon 432 is changed to a to-be-displayed state, and the icon 432 is displayed in the floating window 418. In some embodiments, since the screen space is limited, the icon 432 replaces the icon 420 in the floating window 418. In some embodiments, the icon 432 includes a badge indicating the number of malicious items that have been intercepted. In some embodiments, the badge is continuous updated if the user does not select the icon 432 for an extended period of time, and more malicious information items are intercepted during that extended period of time.

FIG. 4F shows that, when the user has not started the performance testing on the device for more than a predetermined threshold amount of time, the performance test module generates a performance test event. When the performance test event is intercepted by the manager application, according to the processes described above, an icon 434 for the performance test module is identified by the manager program. The state of the icon 434 is changed to a to-be-displayed state, and the icon 434 is displayed in the floating window 418.

In some embodiments, respective icons associated with more than one function modules may have a to-be-displayed state, and the manager program has multiple icons to be displayed in the floating window 418. In some embodiments, the manager program displays the icons one by one in an order according to their respective priority level. In some embodiments, the manager program displays icons with the same priority level together. In some embodiments, the icon for each function module that has generated at least one event is displayed in the floating window for a predetermined amount of time, before the icon for the next function module is displayed. As shown in FIGS. 4D-4F, if all three function modules (e.g., the private information module, the malicious information interception module, and the performance testing module) have all generated at least one events, and are in the to-be-displayed state, the manager program displays their respective icons 430, 432, and 434, one at a time in the floating window 418. In some embodiments, the floating window floats around the display, as the icons are changed within the floating window 418.

FIGS. 4G-4I illustrate exemplary user interfaces presented when the user selects the icon 430 in a locked screen. FIGS. 4J-4L illustrate exemplary user interface presented when the user selects the icon 432 in a locked screen. FIGS. 4M-4O illustrate exemplary user interfaces presented when the user selects the icon 434 in a locked screen.

As shown in FIG. 4G, the user has selected the icon 430 when the floating window 418 is displayed over a lock screen 426 of the device 400. In response to the selection of the icon 430, the manager program determines whether the invoked function module (e.g., the private information module) requires a password. In this example, the manager program determines that the private information module does require a password. In accordance with a determination that the private information module requires authentication, the manager program displays an authentication interface of the private information module (e.g., an authentication window 436) on the display 402. The authentication window 436 requests the use to enter a password for the private information module. In some embodiments, the user can provide a touch-based gesture in an input area of the authentication window 436. Alternatively, the user can invoke a keypad and input the password using the keypad presented in the authentication window 436. In some embodiments, the manager program bypasses the normal device authentication process, if the password for the private information module is the same as or stronger than the password for the device authentication. In such embodiments, once the user has gained access to the private information module by providing the correct password once, the user can exit the private information interface to access the main interface (e.g., the home screen) of the device without providing the password again to unlock the device. In some embodiments, the floating window 418 is displayed over the home screen of the device, the manager program does not make the determination regarding the passwords, and simply presents the authentication interface for the private information module. In some embodiments, the manager program does not present the authentication window 436, if the user selects the icon from the floating window displayed over the home screen of the device. In such embodiments, the manager program directly displays the user interface 416, as shown in FIG. 4I.

As shown in FIG. 4H, in some embodiments, when the manager program displays the authentication interface 436 of the private information module, the home interface of the manager program is also displayed in the background on the display 402. The icons in the home interface of the manager program are inactivated at this time. In some embodiments, the icon corresponding to the private information module is optionally highlighted visually to indicate to the user what functional module would be available for direct access when the user passes the authentication process.

FIG. 4I shows that, as soon as the user provides the correct authentication information for the private information module in the authentication window 436, the manager program presents the respective user interface 416 of the private information module on the display 402. The respective user interface 416 shows the list of private information (e.g., private text messages, private email messages, private voice mail messages, and/or private social media messages, etc.) that have been received on the device. In some embodiments, the user interface 416 also presents various user interface elements (not shown) for invoking various related functions (e.g., delete, reply, or mark a particular message) or for navigating the user interface of the private information module (e.g., go to a particular private message, or exiting to the main interface of the manager program).

As shown in FIG. 4J, the user has selected the icon 432 when the floating window 418 is displayed over a lock screen 426 of the device 400. In response to the selection of the icon 432, the manager program determines whether the invoked function module (e.g., the malicious information interception module) requires a password. In this example, the manager program determines that the malicious information interception module does not require a password. However, since the icon 432 is selected while the device is in a locked state, in accordance with a determination that the device is still in a locked state and requires user authentication, the manager program displays an authentication interface of the device (e.g., an authentication window 438) on the display 402. The authentication window 438 requests the use to enter a password for the device 400. In some embodiments, the user can provide a passcode in an input area of the authentication window 438 using the keypad presented in the authentication window 438. In some embodiments, if the icon 432 is selected while the floating window 418 is displayed over the home screen of the device, the manager program does not present any authentication interface to the user. In such embodiments, the manager application displays the user interface 440 of the malicious information interception module as soon as the user selects the icon 432.

As shown in FIG. 4K, in some embodiments, when the manager program displays the authentication interface 438 of the device, the home interface of the manager program is also displayed in the background on the display 402. The icons in the home interface of the manager program are inactivated at this time. In some embodiments, the icon corresponding to the malicious information interception module is optionally highlighted visually to indicate to the user what functional module would be available for direct access when the user passes the authentication process.

FIG. 4L shows that, as soon as the user provides the correct authentication information for the device in the authentication window 438, the manager program presents the respective user interface 440 of the malicious information interception module on the display 402. The respective user interface 440 shows the list of malicious information items (e.g., spam email messages, spam text messages, virus, Trojan programs, phishing email messages, etc.) that have been intercepted by the malicious information interception module on the device. In some embodiments, the user interface 440 also presents various user interface elements (not shown) for invoking various related functions (e.g., delete, report, or mark a particular item) or for navigating the user interface of the malicious information interception module (e.g., go to a particular malicious information item, or exiting to the main interface of the manager program).

As shown in FIG. 4M, the user has selected the icon 434 when the floating window 418 is displayed over a lock screen 426 of the device 400. In response to the selection of the icon 434, the manager program determines whether the invoked function module (e.g., the performance test module) requires a password. In this example, the manager program determines that the performance test module does not require a password. However, since the icon 434 is selected while the device is in a locked state, in accordance with a determination that the device is still in a locked state and requires user authentication, the manager program displays an authentication interface of the device (e.g., an authentication window 438) on the display 402. The authentication window 438 requests the use to enter a password for the device 400. In some embodiments, the user can provide a passcode in an input area of the authentication window 438 using the keypad presented in the authentication window 438. In some embodiments, if the icon 434 is selected while the floating window 418 is displayed over the home screen of the device, the manager program does not present any authentication interface to the user. In such embodiments, the manager application displays the user interface 442 of the performance test module as soon as the user selects the icon 434.

As shown in FIG. 4N, in some embodiments, when the manager program displays the authentication interface 438 of the device, the home interface of the manager program is also displayed in the background on the display 402. The icons in the home interface of the manager program are inactivated at this time. In some embodiments, the icon corresponding to the performance test module is optionally highlighted visually to indicate to the user what functional module would be available for direct access when the user passes the authentication process.

FIG. 40 shows that, as soon as the user provides the correct authentication information for the device in the authentication window 438, the manager program presents the respective user interface 442 of the performance test module on the display 402. The respective user interface 442 shows the list of performance test and improvement items (e.g., system status test, virus protection test, processor speed test, network speed test, backup process, battery efficiency test, killing idle applications process, etc.) implemented by the performance testing module on the device. In some embodiments, the user interface 442 also presents various user interface elements for invoking various related functions (e.g., fixing a detected problem, improving a particular aspect of the performance, etc.) or for navigating the user interface of the malicious information interception module (e.g., go to a particular test, or exiting to the main interface of the manager program).

The above exemplary user interfaces and function modules are merely illustrative. Other function modules can be provided by the manager program. In some embodiments, a method of providing shortcut access to a sub-function of an application includes one or more of the following steps at a device having one or more processors and memory. The device has a plurality of user applications installed thereon, each user application configured to provide one or more sub-functions to a user through a respective home user interface of the application when a user launches the user application by selecting a respective application icon displayed on a home screen of the device.

In some embodiments, the device establishes one or more respective shortcut access icons (e.g., icons 420, 430, 432, 434) for a plurality of sub-functions provided by the plurality of user applications. The respective shortcut access icons include one or more of a first shortcut access icon (e.g., icon 430) for a first sub-function (e.g., private information module) of a first user application (e.g., a mail application), a second shortcut access icon (e.g., icon 432) for a second sub-function (e.g., a malicious information interception module) of a second user application (a security application, or the manager application that combines the security functions of multiple applications), and a third shortcut access icon (e.g., icon 434) for third sub-function (e.g., performance test module) of a third user application (e.g., a performance management application or the manager application that combines the performance enhancement functions of multiple applications), and a fourth shortcut access icon (e.g., icon 420) for a fourth function (e.g., main function module) of a fourth user application (e.g., the manager application).

In some embodiments, the device monitors, in real-time, events generated on the device.

In some embodiments, the device determines whether a respective event detected on the device is related to one of the plurality of sub-functions provided by the plurality of user applications.

In some embodiments, in response to detecting a respective first event related to the first sub-function of the first user application, the device changes a respective display state of the first shortcut access icon from a hidden state to a to-be-displayed state.

In some embodiments, in response to detecting a respective second event related to the second sub-function of the second user application, the device changes a respective display state of the second shortcut access icon from the hidden state to the to-be-displayed state.

In some embodiments, in response to detecting a respective third event related to the third sub-function of the third user application, the device changes a respective display state of the third shortcut access icon from the hidden state to the to-be-displayed state.

In some embodiments, the device monitors, in real-time, the respective display states of the plurality of shortcut access icons, including the respective display states of the first shortcut access icon, the second shortcut access icon, and the third shortcut access icon.

In some embodiments, based on the monitoring, the device displays, in real-time, at least a respective one of the respective shortcut access icons currently having the to-be-displayed state in a floating window over the home screen or a lock screen of the device.

In some embodiments, the device receives a selection input on the respective shortcut access icon currently displayed in the floating window.

In some embodiments, in response to the selection input: the device ceases to display the home screen or the lock screen of the device; and displays a respective user interface providing direct access to the respective sub-function associated with the respective shortcut access icon, going through the respective home user interface of the respective application providing the respective sub-function.

In some embodiments, before displaying the respective user interface providing direct access to the respective sub-function associated with the respective shortcut access icon, the device determines if a function-specific password is required for accessing the function module associated with the respective shortcut access icon. If so, the device displays a functional-specific authentication interface to the user. If not, the device determines if the device is currently in a locked state. If so, the device displays an authentication interface for unlocking the device. If not, the device displays the respective user interface of the function module associated with the selected shortcut access icon. In addition, if an authentication interface is displayed, and a user passes the required authentication, the device displays the respective user interface of the function module associated with the selected shortcut access icon.

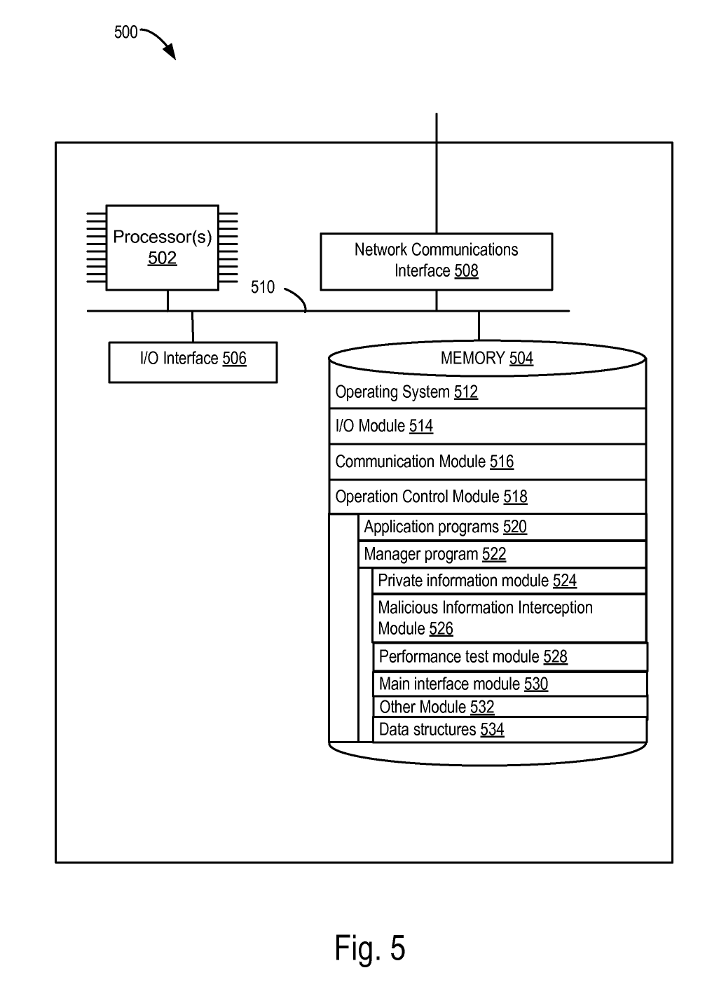

FIG. 5 is a block diagram of a system 500 for implementing the method of entering a function module (e.g., providing direct access to a sub-function of an application), as described above, in accordance with some embodiments. In some embodiments, the system 500 is one of: a mobile device, a PDA, a smartphone, a handheld computer, and a tablet computer.

As shown in FIG. 5, the system 500 includes one or more processing units (also called herein “processors”) 502, memory 504, an input/output (I/O) interface 506, and a network communications interface 508. These components communicate with one another over one or more communication buses or signal lines 510. In some embodiments, the memory 504, or the computer readable storage media of memory 504, stores programs, modules, instructions, and data structures including all or a subset of: an operating system 512, an I/O module 514, a communication module 516, and an operation control module 518. The one or more processors 502 are coupled to the memory 504 and operable to execute these programs, modules, and instructions, and reads/writes from/to the data structures.

In some embodiments, the processing units 502 include one or more microprocessors, such as a single core or multi-core microprocessor. In some embodiments, the processing units 502 include one or more general purpose processors. In some embodiments, the processing units 502 include one or more special purpose processors.

In some embodiments, the memory 504 includes high-speed random access memory, such as DRAM, SRAM, DDR RAM or other random access solid state memory devices. In some embodiments the memory 504 includes non-volatile memory, such as one or more magnetic disk storage devices, optical disk storage devices, flash memory devices, or other non-volatile solid state storage devices. In some embodiments, the memory 504 includes one or more storage devices remotely located from the processing units 502. The memory 504, or alternately the non-volatile memory device(s) within the memory 504, comprises a computer readable storage medium.

In some embodiments, the I/O interface 506 couples one or more input/output devices, such as displays, a keyboards, touch screens, speakers, and microphones, to the I/O module 514 of the system 500. The I/O interface 506, in conjunction with the I/O module 514, receive user inputs (e.g., voice input, keyboard inputs, touch inputs, etc.) and process them accordingly. The I/O interface 506 and the I/O module 514 also present outputs (e.g., sounds, images, text, etc.) to the user according to various program instructions implemented on the system 500.

In some embodiments, the network communications interface 508 includes wired communication port(s) and/or wireless transmission and reception circuitry. The wired communication port(s) receive and send communication signals via one or more wired interfaces, e.g., Ethernet, Universal Serial Bus (USB), FIREWIRE, etc. The wireless circuitry receives and sends RF signals and/or optical signals from/to communications networks and other communications devices. The wireless communications may use any of a plurality of communications standards, protocols and technologies, such as GSM, EDGE, CDMA, TDMA, Bluetooth, Wi-Fi, VoIP, Wi-MAX, or any other suitable communication protocol. The network communications interface 508 enables communication between the system 500 with networks, such as the Internet, an intranet and/or a wireless network, such as a cellular telephone network, a wireless local area network (LAN) and/or a metropolitan area network (MAN), and other devices. The communications module 516 facilitates communications between the system 500 and other devices (e.g., the first client device and the second client device) over the network communications interface 508.

In some embodiments, the operating system 502 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

In some embodiments, the system 500 is implemented on a portable electronic device (e.g., a smart phone, a mobile phone, a tablet computer, etc.). It should be noted that the system 500 is only one example, and that the system 500 may have more or fewer components than shown, may combine two or more components, or may have a different configuration or arrangement of the components. The various components shown in FIG. 5 may be implemented in hardware, software, firmware, including one or more signal processing and/or application specific integrated circuits, or a combination of thereof.

In FIG. 5, the operation control module 518 includes various application programs 520, a manager program 522. The manager program includes one or more function modules (e.g., private information module 524, malicious information interception module 526, performance test module 528, main interface module 530, other function modules 532, etc.). As shown in FIG. 5, the system 500 stores the operation control module 518 in the memory 504. In some embodiments, the operation control module 518 further includes data structures 534 such as the correspondence between events and icons, the correspondence between events and priority levels, the correspondence between icons and function identifiers, etc. In some embodiments, the operation control module 518 optionally includes one or more other modules (not shown) to provide other related functionalities described herein. Details on the structures, functions, and interactions of the operation control module 518 are provided with respect to FIGS. 1-4O and accompanying descriptions.

It may be understood by persons of ordinary skill in the art that: all or part of the steps in the foregoing embodiments may be completed through hardware, or through a program instructing related hardware. The program may be stored in a computer readable storage medium, and the mentioned storage medium may be a read-only memory, a magnetic disk or an optical disk.

The foregoing descriptions are merely preferable embodiments of the present invention, but are not intended to limit the present invention. Any modifications, equivalent replacements and improvements made without departing from the spirit and principle of the present invention shall all fall within the protection scope of the present invention.

What is claimed is:

1. A method for providing direct access to a sub-function of an application, comprising:
at a device having one or more processors and memory:
intercepting an event generated by a function module of an application;
obtaining an icon corresponding to the function module according to the intercepted event;
displaying the obtained icon corresponding to the function module;
receiving a click event submitted by a user through the icon;
obtaining a function identifier of the function module corresponding to the icon; and
providing direct access to the corresponding function module according to the function identifier without first invoking a main user interface of the application.

2. The method according to claim 1, wherein the obtaining and displaying the icon corresponding to the function module according to the event further comprises:
obtaining, according to the event, the icon of the function module corresponding to the event from stored correspondence between events and icons;
setting a state of the icon as a to-be-displayed state and setting a priority level of the icon according to the event; and
selecting the icon in the to-be-displayed state according to the priority level, and displaying the selected icon.

3. The method according to claim 2, wherein the setting the priority level of the icon according to the event further comprises:
obtaining, according to the event, a corresponding priority level from stored correspondence between events and priority levels; and
setting the priority level of the icon to the obtained priority level.

4. The method according to claim 1, wherein the obtaining the function identifier of the function module corresponding to the icon comprises:
obtaining the function identifier of the function module corresponding to the icon from stored correspondence between icons and function identifiers.

5. The method according to claim 1, wherein providing direct access to the corresponding function module according to the function identifier further comprises:
determining the corresponding function module according to the function identifier;
opening a function interface of the function module;
obtaining to-be-displayed content corresponding to the function module; and
displaying the obtained to-be-displayed content in the function interface without first invoking the main user interface of the application.

6. The method according to claim 1, wherein before the obtaining the icon corresponding to the event, the method further comprises:
performing real-time monitoring on a plurality of function modules of the application to determine whether any function module of the application generates an event.

7. A system, comprising:
one or more processors; and
memory having instructions stored thereon, the instructions, when executed by the one or more processors, cause the processors to perform operations comprising:
intercepting an event generated by a function module of an application;
obtaining an icon corresponding to the function module according to the intercepted event;
displaying the obtained icon corresponding to the function module;
receiving a click event submitted by a user through the icon;
obtaining a function identifier of the function module corresponding to the icon; and
providing direct access to the corresponding function module according to the function identifier without first invoking a main user interface of the application.

8. The system according to claim 7, wherein the obtaining and displaying the icon corresponding to the function module according to the event further comprises:
obtaining, according to the event, the icon of the function module corresponding to the event from stored correspondence between events and icons;
setting a state of the icon as a to-be-displayed state and setting a priority level of the icon according to the event; and
selecting the icon in the to-be-displayed state according to the priority level, and displaying the selected icon.

9. The system according to claim 8, wherein the setting the priority level of the icon according to the event further comprises:
obtaining, according to the event, a corresponding priority level from stored correspondence between events and priority levels; and
setting the priority level of the icon to the obtained priority level.

10. The system according to claim 7, wherein the obtaining the function identifier of the function module corresponding to the icon comprises:
obtaining the function identifier of the function module corresponding to the icon from stored correspondence between icons and function identifiers.

11. The system according to claim 7, wherein providing direct access to the corresponding function module according to the function identifier further comprises:
determining the corresponding function module according to the function identifier;
opening a function interface of the function module;
obtaining to-be-displayed content corresponding to the function module; and
displaying the obtained to-be-displayed content in the function interface without first invoking the main user interface of the application.

12. The system according to claim 7, wherein before the obtaining the icon corresponding to the event, the method further comprises:
performing real-time monitoring on a plurality of function modules of the application to determine whether any function module of the application generates an event.

13. A non-transitory computer-readable medium having instructions stored thereon, the instructions, when executed by one or more processors, cause the processors to perform operations comprising:
intercepting an event generated by a function module of an application;
obtaining an icon corresponding to the function module according to the intercepted event;
displaying the obtained icon corresponding to the function module;
receiving a click event submitted by a user through the icon;
obtaining a function identifier of the function module corresponding to the icon; and
providing direct access to the corresponding function module according to the function identifier without first invoking a main user interface of the application.

14. The computer-readable medium according to claim 13, wherein the obtaining and displaying the icon corresponding to the function module according to the event further comprises:
obtaining, according to the event, the icon of the function module corresponding to the event from stored correspondence between events and icons;
setting a state of the icon as a to-be-displayed state and setting a priority level of the icon according to the event; and
selecting the icon in the to-be-displayed state according to the priority level, and displaying the selected icon.

15. The computer-readable medium according to claim 14, wherein the setting the priority level of the icon according to the event further comprises:
obtaining, according to the event, a corresponding priority level from stored correspondence between events and priority levels; and
setting the priority level of the icon to the obtained priority level.

16. The computer-readable medium according to claim 13, wherein the obtaining the function identifier of the function module corresponding to the icon comprises:
obtaining the function identifier of the function module corresponding to the icon from stored correspondence between icons and function identifiers.

17. The computer-readable medium according to claim 13, wherein providing direct access to the corresponding function module according to the function identifier further comprises:
determining the corresponding function module according to the function identifier;
opening a function interface of the function module;
obtaining to-be-displayed content corresponding to the function module; and
displaying the obtained to-be-displayed content in the function interface without first invoking the main user interface of the application.

18. The computer-readable medium according to claim 13, wherein before the obtaining the icon corresponding to the event, the method further comprises:
performing real-time monitoring on a plurality of function modules of the application to determine whether any function module of the application generates an event.
